(19) United States
(12) Patent Application Publication
(10) Pub. No.: US 2010/0287216 A1
(43) Pub. Date: Nov. 11, 2010

(54) Grouped space allocation for copied objects

(75) Inventor: Tatu J. Ylonen, Espoo (FI)

Correspondence Address: TATU YLONEN OY, LTD., KUTOJANTIE 3, ESPOO, 02630, FI

(73) Assignee: TATU YLONEN OY LTD, Espoo (FI)

(21) Appl. No.: 12/436,821

(22) Filed: May 7, 2009

(51) Int. Cl. G06F 17/30; G06F 12/00

(52) U.S. Cl. 707/813; 711/E12.009; 711/170; 707/661

(57) ABSTRACT

A method of efficiently allocating space for copied objects during garbage collection by grouping many objects together, and after determining which objects belong to a group, allocating space for them in one unit and copying the objects to the allocated space (possibly in parallel).

### CROSS-REFERENCE TO RELATED APPLICATIONS

Not Applicable

### INCORPORATION-BY-REFERENCE OF MATERIAL SUBMITTED ON ATTACHED MEDIA

Not Applicable

### TECHNICAL FIELD

The present invention relates to memory management in computer systems, particularly garbage collection in multiprocessor systems.

### BACKGROUND OF THE INVENTION

An extensive survey of garbage collection is provided by the book R. Jones and R. Lins: Garbage Collection: Algorithms for Dynamic Memory Management, Wiley, 1996.

Examples of modern garbage collectors can be found in Detlefs et al: Garbage-First Garbage Collection, ISMM'04, ACM, 2004, pp. 37-48, and Pizlo et al: STOPLESS: A Real-Time Garbage Collector for Multiprocessors, ISMM'07, ACM, 2007, pp. 159-172.

In many multithreaded garbage collectors many threads may be copying objects simultaneously into a single target memory region. These threads must concurrently allocate space for copied objects in the “to” space, and an efficient means of allocating space from such a region is needed.

Allocation using a NEW pointer has been described, e.g., in R. H. Halstead, Jr.: Implementation of Multilisp: Lisp on a Multiprocessor, Symposium on Lisp and Functional Programming, ACM, 1984, pp. 9-17. In Halstead's system, every processor has its own newspace, located in an area of “local” memory, giving each processor its own private newspace in which to create objects, eliminating contention between processors for allocation from the heap.

In the system described in B. Steensgaard: Thread-Specific Heaps for Multi-Threaded Programs, ISMM'00, ACM, 2000, pp. 18-24, the memory manager allocated memory to threads in chunks to eliminate the need to obtain a lock from the common path in the object allocation code (p. 20, lower left column).

In U.S. Pat. No. 6,826,583, the shared memory is partitioned into a “from” semi-space and a “to” semi-space, and each of a plurality of the garbage collection threads fetches the copy pointer (i.e., the NEW pointer) and increments it by the size of the local buffer (these were called chunks in Steensgaard, where it was suggested that the size of the buffer is an integral number of pages [currently 4 KB]), and a plurality of live objects are copied to such a buffer by a garbage collection thread, eliminating the need to obtain a lock (i.e. contention between processors) from the common path in the object allocation code.

In this specification, thread-local allocation buffers (which are roughly the same as chunks or per-process/per-thread newspaces) are called LABs (Local Allocation Buffers). The central idea of a LAB is to first allocate a largish chunk of space to a thread, and then as objects to be copied are encountered, allocate space from that chunk without any inter-processor synchronization, as long as space remains in the chunk. When a LAB is allocated, it is not yet known which objects, how many objects, or how big objects in total will be copied to it. LABs typically have a fixed size during an execution of a program.

In some systems there may be more than one LAB per garbage collection thread. For example, Steensgaard had one for a thread-specific heap and another for a shared heap.

As the number of processing cores increases the overhead of LAB-based memory allocation also increases. One of the problems is that each LAB reserves a relatively large amount of memory. For example, if a LAB is 64 kilobytes, with 64 processors the system would use four megabytes for LABs. On the average half of that space would be left unused at the end of garbage collection, with the unused space scattered around the target memory region(s). Already today, off-the-shelf shared memory systems with 864 processors are available. If all processors participate in garbage collection on such systems, over 55 megabytes of memory will be needed with 64 kB LABs. There is currently significant research activity relating to computers with very many relatively simple processing cores, as such systems promise to provide much improved MIPS/Watt figures compared to more traditional computers.

Each processing core may also need to allocate objects from several memory regions. For example, in some embodiments a processing core might copy objects to more than one generation. In other embodiments additional criteria might be used to further segregate objects, such as reachability from global variables vs. local variables, distance from certain objects serving as cluster centers in a persistent object system, etc.

If there are 100 clusters (or generations, or other “groups”), on a 864 processor system with 64 kB LABs as much as 5.5 gigabytes of space could be needed for the LABs. While a practical system would probably not use 864 processors to perform garbage collection in parallel, and LABs would probably not be constantly kept for all clusters by all processors, the general technological trend is to have more and more cores and memory buses in high-end server computers, and the overhead of LAB-based allocation can become substantial in increasingly many systems.

LAB-based allocation can also be troublesome in very small systems for mobile devices. Such devices may use multiple processing cores to reduce power consumption (two cores at half speed consume much less power than one faster core), but may not have much memory to waste. It is expected that garbage collection based languages and applications will be widely used even on mobile devices in the future.

### BRIEF SUMMARY OF THE INVENTION

The objective of the present invention is to permit efficient allocation of many small objects by many threads executing in parallel without using LABs and without incurring the overhead of allocating each object separately from a global pool. This is achieved by grouping many objects together, allocating space for them using substantially a single atomic operation (usually in response to the group having grown too big), and then copying the objects into the allocated space.

The solution is primarily targeted for use in garbage collectors. However, there are also other applications that perform similar operations. Persistent and distributed object systems and databases, for example, need to cluster related objects for fast loading (such systems may also slightly modify objects during copying, such as replacing in-memory pointers by persistent object identifiers, as known in the art). Serialization systems (as well as some persistent or distributed object systems) may encode the objects into a (usually more compact) transfer encoding during copying, for example for transmission to a different node in a distributed system or for storage in a database. Any known serialized data format may serve as the transfer encoding.

The size of the group can be adjusted dynamically. In some embodiments the space requirements (size) of the group are computed incrementally as objects are added to the group, and when the group has grown large enough, space is allocated for all objects in the group in a single operation and actual copying is performed. Offsets of the objects within the allocated space may be computed before or after allocation. Several objects can be copied in parallel.

The solution is particularly well suited for garbage collectors that identify objects with more than one reference in the object graph prior to copying. Such objects are roots of (possibly degenerate) maximal trees of objects. In such embodiments it suffices to keep track of the objects with multiple references and to have such objects stand for all objects in the respective tree. The size (memory space) required for the entire tree is then used as the size of such an object in the group. It is thus not always necessary to list all objects in the group in bookkeeping.

The method is also useful in other garbage collectors. Adding objects into a fixed-size array can be done very quickly, and postponing copying until enough objects have been traversed to make a reasonably sized group reduces cache and memory bus contention during traversing allowing it to run faster. When doing the actual copying, the objects read during traversing for the group are usually still in cache, and only need to be written sequentially into memory. Since sequential writes are much faster than random writes, the method may also yield useful speedups in uniprocessor systems and in multiprocessor systems using almost any copying (or compacting) garbage collection approach.

### BRIEF DESCRIPTION OF THE SEVERAL VIEWS OF THE DRAWING(S)

FIG. 1 illustrates a computer with an object grouper, a group allocator, a space divider and a group copier.

FIG. 2 illustrates collecting objects into one or more groups and triggering the copying of a group.

FIG. 3 illustrates adding an object into a group.

FIG. 4 illustrates copying a group.

### DETAILED DESCRIPTION OF THE INVENTION

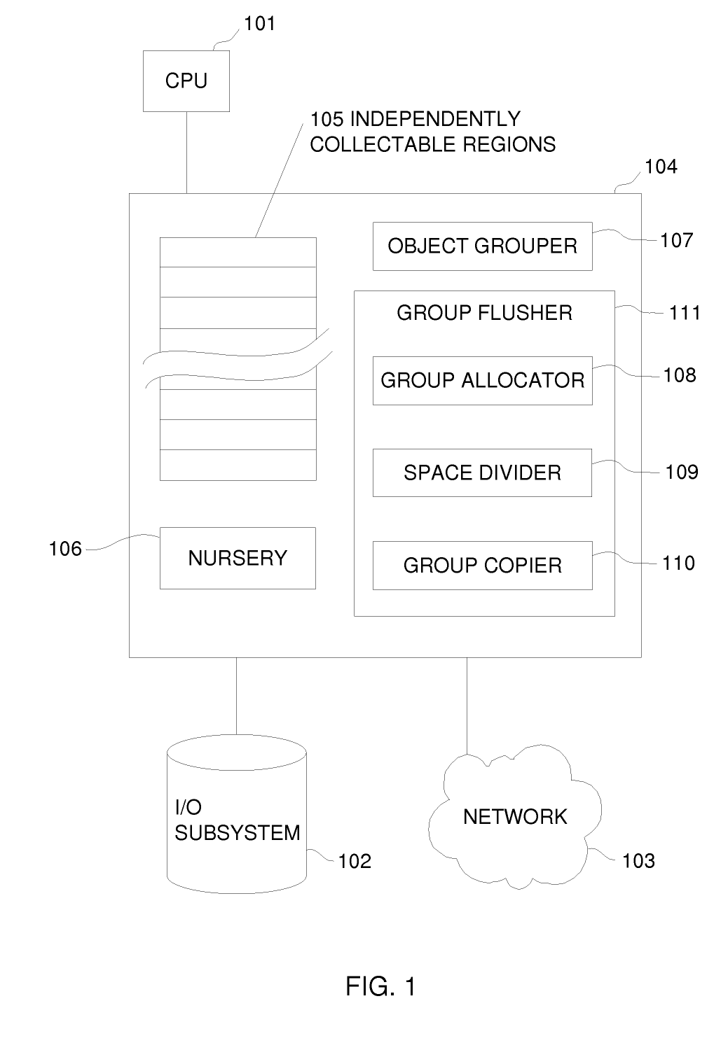

FIG. 1 illustrates a computer system according to a possible embodiment of the invention. (101) illustrates one or more processors (each processor may execute one or more threads), (102) illustrates an I/O subsystem, typically including a non-volatile storage device, (103) illustrates a communications network such as an IP (Internet Protocol) network, a cluster interconnect network, or a wireless network, and (104) illustrates one or more memory devices such as semiconductor memory.

(105) illustrates one or more independently collectable memory regions. They may correspond to generations, trains, semi-spaces, areas, or regions in various garbage collectors. (106) illustrates a special memory area called the nursery, in which young objects are created.

In some embodiments the nursery may be one of the independently collectable memory regions, and may be dynamically assigned to a different region at different times. The division between memory regions does not necessarily need to be static.

(107) illustrates an object grouper. It is a component for constructing one or more groups of objects to be copied. One or more threads may be performing garbage collection (or other memory management operations) and grouping objects into groups. Some of the groups may be local to a thread (that is, only that thread adds objects to the group), whereas other groups may be shared (requiring synchronization, such as locking, to ensure consistent updates by multiple threads). The maximum number of objects in a group may be fixed or dynamic. A group may be implemented, e.g., as an array of slots (each typically describing an object), a list of object descriptors, a hash table of object descriptors (preferably keyed by a pointer to the object, so that it can be quickly checked whether an object is already in the group). In some embodiments the groups may be complemented by a global hash table mapping object pointers to groups in which they have been added.

In certain embodiments, such as with multiobject garbage collection (co-owned U.S. patent application Ser. No. 12/147,419), only roots of maximal trees of objects in the object graph need to be explicitly added to a group. The root being in the group will then imply that all objects in the tree belong to the group. Such an approach can be used advantageously in any system where it is known at grouping time which objects in the memory region of interest (usually the nursery) have more than one reference (such objects and only such objects are roots of maximally large trees in the object graph).

The exact method used for grouping is not essential for the present invention, and the invention practiced with any particular grouping method. However, some grouping means must be used.

It is an essential differentiating characteristic of the present invention that the grouping (determining which objects go in a group) is performed before space is allocated for the group. This is in contrast with a LAB, where space is allocated for the LAB before it is known which objects will be copied to that space.

While according to the present invention objects for a particular group are determined before allocating space for the group, this does not imply that other groups would need to be completely determined when the group is flushed.

(111) illustrates a group flusher, which performs space allocation, space dividing, and copying for a group. Its main components are the group allocator (108), space divider (109) and group copier (110). However, it should be understood that especially the space divider could be mostly integrated into the object grouper (e.g., by calculating object offsets when they are added to a group).

(108) illustrates the group allocator. Its purpose is to allocate space for the entire group. In many embodiments, it will use a single atomic operation (or lock) to allocate memory from a pool shared by more than one thread. However, using atomic operations may be unnecessary in uniprocessor embodiments, and more than one atomic operation could be used in some other embodiments (the number of atomic operations however being fewer than the number of objects in the group).

One skilled in the art could construct an embodiment where space for the group is allocated in two or more chunks, at least some of the chunks being large enough for more than one object. The total space thus allocated could be contiguous or discontiguous. Whether such embodiments are viewed as each chunk corresponding to a separate group or as a group being allocated discontiguous memory which is then divided to the objects suitably, they are intended to be within the scope of the invention. For simplicity the invention is described as only one contiguous chunk being allocated.

A very simple group allocator could use code similar to the following (‘next_new_addr’ is the next available address for allocation, a global variable; COMPARE_AND_SWAP refers to using an atomic compare-and-swap instruction as is known in the art):

```
do {
  addr = next_new_addr;
  next_addr = addr + group_size;
} while (COMPARE_AND_SWAP(next_new_addr, addr,
                              next_addr) != addr);
```

A real allocator would probably need to include code to switch to a new allocation region when the previous one becomes full.

(109) illustrates a space divider. Its purpose is to divide the space allocated by the group allocator to the individual objects in the group.

There are at least three possible approaches to dividing the space. In the first approach, as each object is added to a group, the offset at which the object will be stored in the allocated space is stored with the object's pointer in the group (thus, the slot in the group data structure used to store information about the object also contains its offset). Then, only the starting address of the group needs to be saved when the space is allocated, and each object is copied to the address that is the starting address plus the object's offset in the group. This approach lends itself particularly well to parallel copying. The offset is preferably the size of the group before adding the current object.

In the second approach, after the space has been allocated, the space divider iterates over objects in the group, assigning a new address for each of them. This approach is also suitable for parallel copying.

In the third approach, space is allocated for each object as it is copied. In this case the space divider and object copier are essentially combined into the same element. In some ways this approach resembles using the space allocated for the group as a LAB, however of size exactly matching the total space requirement of objects in the group. However, there is an advantage compared to LAB-based allocation: there is no need to check if the allocated buffer contains enough space, as we know we have allocated enough space to store all objects in the group. Thus copying becomes faster. (Another difference to LAB-based approaches is that here objects are first grouped together, and then space is allocated and the already predetermined objects copied, whereas in LAB-based approaches space for the LAB is first allocated, and then a plurality of objects are copied into it as they are encountered.)

(110) illustrates the group copier, which copies the objects in the group. If the new address for each object has been determined before copying starts, the copying can be easily parallelized (e.g., by dividing the group into subgroups and processing each subgroup by a thread, or by putting the copy operations on one or more worklists from which several threads take work). Parallelization at this level is not easily possible/efficient with LAB-based approaches. This type of parallelism might lend itself well to VLIW (Very Long Instruction Word) machines, which can perform more than one instruction simultaneously.

In embodiments where only the roots of trees in the object graph are stored in the group (but stand for the entire subtree), each copy operation would perform a traversal of the tree in the object graph. If it is known which objects are roots of subtrees, the traversal would not need to perform any cycle detection and would not need to store forwarding pointers within the tree. Furthermore, if the maximum size of groups is limited, a fixed-size stack can be used for the traversal, eliminating any checks for stack overflow. The traversal could basically be simple depth-first traversal with fixed-size stack, and at each outgoing pointer it would be checked whether it points to within the region of interest and whether the pointed object is a root of a maximal tree (e.g., by indexing a bitmap by the address of the object minus the starting address of the region of interest divided by minimum object size or alignment).

In many embodiments of root-based grouping, the objects in the tree would probably still be in the processor's cache from the grouping phase, and thus the traversal operation could be extremely fast. Performance of the copying would in many cases be limited by the memory bandwidth available for sequentially writing the object into the new region. This could be significantly faster than traditional copying garbage collection, where forwarding pointers need to be updated (which updates are random writes to many cache lines around the heap).

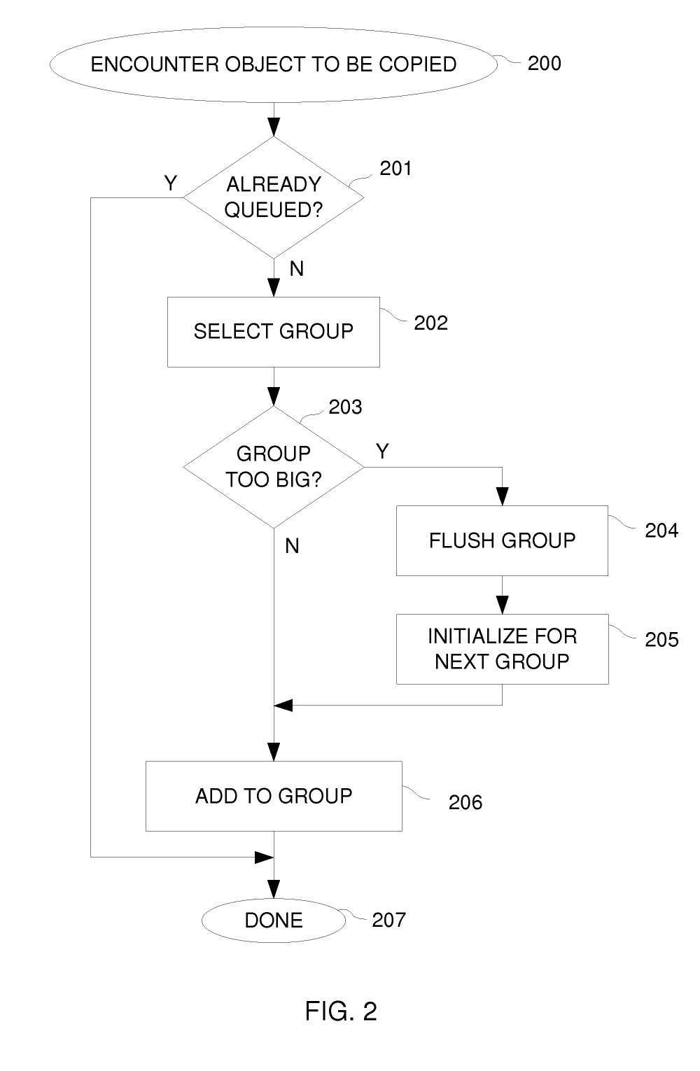

FIG. 2 illustrates one possible grouping method. Starting at (200), it illustrates actions taken when an object (or maximal tree root in some embodiments) is encountered while traversing the object graph during garbage collection. At (201), it is checked if the object is already queued. This check is optional, and is not needed in some embodiments. If it is present, it may use, e.g., a bitmap, a flag in object header, presence of a forwarding pointer, a hash table, or any suitable index data structure to determine whether the object has already been queued.

At (202) the group in which the object should be added is selected. This selection may be based on any suitable criteria, including but not limited to: age of the object, age of the region in which it resides, generation, reachability from permanent roots, class of the object, connectivity from a cluster, NUMA node, home node in a distributed object system, persistence information, etc. Some of this information is readily available, while some may be approximately computed e.g. by a global snapshot-at-the-beginning tracing operation or a global multiobject-level transitive closure computation.

At (203) it is checked if the group has grown too big. This could e.g. compare the number of objects in the group against a maximum, the size of the group (preferably with the size of the current object and alignment padding added) against a maximum, or some other suitable criterion.

One skilled in the art could also construct an embodiment wherein objects are collected into groups without checking if a group becomes too big at each addition, and later splitting any groups that have grown too big. The step (203) could thus be postponed to such later splitting stage, without deviating from the spirit of the invention.

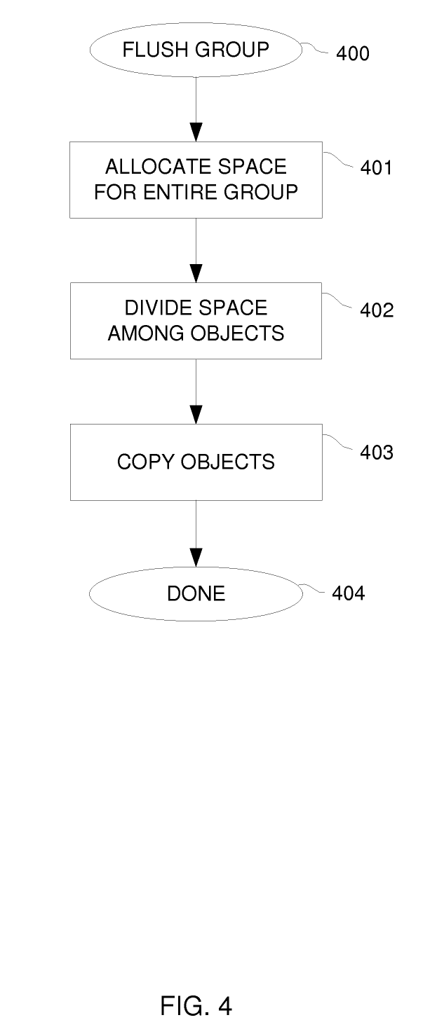

At (204) the group is flushed (i.e., space for it is allocated, the objects are copied, and a new group may be started). This is illustrated in FIG. 4. At (205) a new group is started (e.g., by zeroing the number of objects and current size in a group descriptor or allocating a new descriptor).

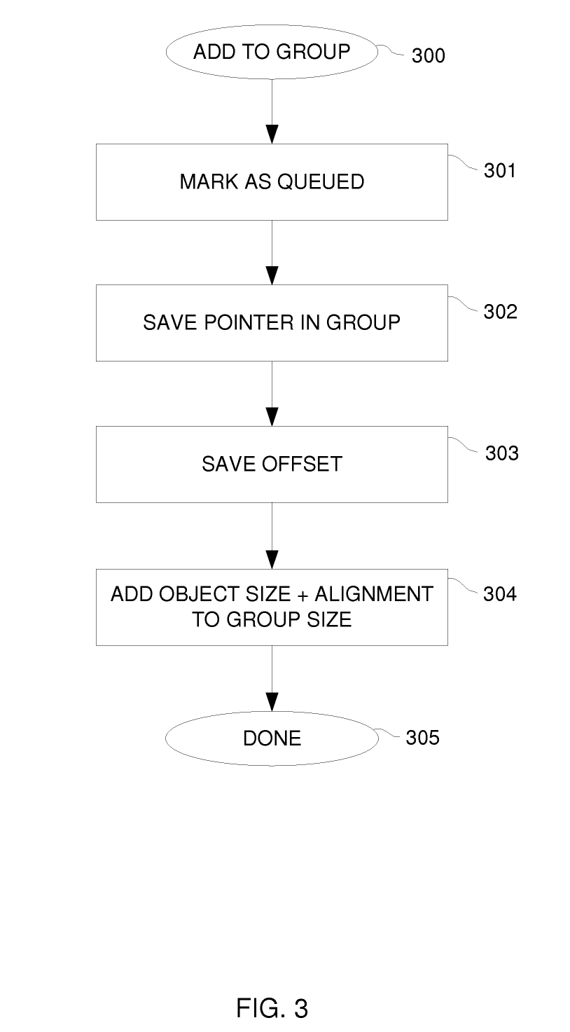

At (206) the object is added to the group. This could also be done before the check at (203). This is illustrated in more detail in FIG. 3. Handling the encountered object is complete at (207).

FIG. 3 illustrates adding an object to a group in a possible embodiment. The operation starts at (300). At (301) the object is optionally marked as queued, as already discussed with step (201). At (302) a pointer to the object is saved in the group. At (303) the offset of the object in the group is set (by saving the current size of the group). At (304) the size of the object is added to the size of the group. At (305) the operation is complete.

If only the roots of trees of the object graph are added, then the size of the object would be the combined size of the tree whose root it is. (Alignment may be added to all sizes as appropriate in a particular embodiment, such that the offsets remain properly aligned.)

If a transfer encoding is produced while copying, then the size of the transfer encoding may be used as the size of an object/tree.

FIG. 4 illustrates flushing a group. The operation starts at (400). At (401) space is allocated for the entire group. At (402), the space is divided among objects (in the preferred embodiment, the offsets for all objects are computed while adding them to the group, and thus dividing the space is done intermixed with adding objects to the group). At (403) the objects in the group are copied, using one or more threads. At (404) the operation is complete.

In many embodiments all groups are flushed before the end of an evacuation interval.

Even though trees were described as being maximal (that is, their root is not part of any other tree and extending to all referenced objects with exactly one reference), it is also possible to arbitrarily split trees, e.g. in order to limit their size, confine them into a subset of the independently collectable memory regions, or to exclude large or popular objects. The first object not belonging to the tree could then be treated identically to an object with more than one reference for the purposes of this disclosure, and would be the root of another tree. Thus, the invention does not necessarily require that the trees actually be maximal.

One aspect of the invention is a method of allocating space for copied objects in a computer comprising a group flusher, the method comprising:
collecting more than one object into one or more groups of objects to be copied; and
in response to one of the groups growing too big, flushing the group.

As discussed above, flushing comprises allocating space for the entire group and copying each object in the group to its allocated space. The allocated space may be divided to individual objects either as a separate step after allocation or offsets may be computed already when adding the objects into the group.

Another aspect of the invention is a computer comprising:
an object grouper; and
a group flusher configured to allocate space for and copy the objects contained in a group in response to the group becoming too big.

A third aspect of the invention is a computer readable medium operable to cause a computer to:
collect more than one object into a group of objects to be copied; and
in response to the group having grown too big:
   allocate space for the entire group; and
   copy each object in the group to its allocated space.

Such a medium may also be embedded within a computer (for example, a flash memory device or magnetic disk) and may or may not comprise a processor itself.

Any number of groups may be in the process of being built simultaneously.

Many variations of the above described embodiments will be available to one skilled in the art without deviating from the spirit and scope of the invention as set out herein and in the claims. In particular, some operations could be reordered, combined, or interleaved, or executed in parallel, and many of the data structures could be implemented differently. Where a singular is used, two or more corresponding elements or steps could also occur.

Pointers to objects can be any known means of identifying an object, such as a memory address, a tagged memory address, a pointer or index to an indirection table, a persistent object identifier, or a stub/scion/delegate in a distributed system.

It is to be understood that the aspects and embodiments of the invention described herein may be used in any combination with each other. Several of the aspects and embodiments may be combined together to form a further embodiment of the invention. A method, a computer, or a computer readable medium which is an aspect of the invention may comprise any number of the embodiments or elements of the invention described herein.

What is claimed is:

1. A method of allocating space for copied objects in a computer comprising a group flusher, the method comprising:
collecting more than one object into one or more groups of objects to be copied; and
in response to one of the groups growing too big, flushing the group.

2. The method of claim 1, wherein flushing the group comprises:
allocating space for the entire group;
dividing the allocated space among the objects in the group; and
copying each object in the group to its allocated space.

3. The method of claim 1, wherein the objects added to a group represent trees of objects rooted at said objects.

4. The method of claim 1, wherein collecting objects into the group comprises incrementally computing the size of the group as objects are added to the group.

5. The method of claim 4, wherein the offset of each object in the group is computed when it is added to the group.

6. The method of claim 1, wherein space for the entire group is allocated using substantially a single atomic operation.

7. The method of claim 1, wherein the group into which an object is added is selected at least partially in response to its age.

8. The method of claim 1, wherein the group into which an object is added is selected at least partially based on its proximity to a cluster.

9. The method of claim 1, wherein at least one group is local to a garbage collection thread.

10. The method of claim 1, wherein at least one group is shared by more than one garbage collection thread.

11. The method of claim 1, wherein the flushing comprises replacing at least one pointer in at least one object by a persistent object identifier.

12. The method of claim 1, wherein the flushing comprises encoding at least one object into a transfer encoding.

13. The method of claim 1, wherein the flushing comprises copying at least two objects in the group at least partially in parallel.

14. A computer comprising:
an object grouper; and
a group flusher configured to allocate space for and copy the objects contained in a group in response to the group becoming too big.

15. The computer of claim 14, wherein the group flusher comprises:
a group allocator configured to allocate space for objects in a group; and
a group copier configured to copy the objects in the group to the space allocated by the group allocator.

16. The computer of claim 14, wherein the object grouper is configured to store roots of trees of objects in at least one group, said roots representing all objects in trees rooted by said roots.

17. The computer of claim 14, wherein the object grouper is configured to select a group for each of a plurality of objects to be copied, the selection based at least partially on the age of the objects.

18. The computer of claim 14, wherein the object grouper assigns for each object added to a group an offset at which it will be stored in the space to be allocated for the group.

19. The computer of claim 14, wherein the object grouper is configured to select the group of an object at least partially in response to its distance from a cluster center.

20. A computer readable medium operable to cause a computer to:
collect more than one object into a group of objects to be copied; and
in response to the group having grown too big:
allocate space for the entire group, and
copy each object in the group to its allocated space.
